(19) United States
(12) Patent Application Publication
(10) Pub. No.: US 2010/0153351 A1
(43) Pub. Date: Jun. 17, 2010

(54) TECHNIQUES FOR REAL-TIME DATABASE PROCESSING

(76) Inventors: Alex P. Yung, Anaheim, CA (US); Thomas William Burlew, Woodland Hills, CA (US)

Correspondence Address: JAMES M. STOVER;TERADATA CORPORATION, 2835 MIAMI VILLAGE DRIVE, MIAMISBURG, OH, 45342, US

(21) Appl. No.: 12/335,853

(22) Filed: Dec. 16, 2008

(51) Int. Cl. G06F 17/30; G06F 12/16

(52) U.S. Cl. 707/703; 707/E17.009

(57) ABSTRACT

Techniques for real time data processing are provided. Unprocessed database transactions are represented in messages that are captured in files and stored in directories. The order of the files can be user-defined within the directory. The files are then processed to committed transactions that are committed to a database for updating. Checkpoints can occur at user-defined or data-driven points for failover recovery processing.

### BACKGROUND

One important aspect of Active Data Warehousing (ADW) is the support of mission-critical applications, which usually have very stringent requirements in performance, availability, accessibility, and recoverability. In fact, it becomes even more complicated when data from different sources with different types of data (e.g., files, tables, queues, etc.) are required to be filtered, transformed, synchronized, and/or merged at the right time based on their relationships and then delivered to the data warehouse in a timely manner or in real time.

With traditional ADW solutions, transaction processing is usually queue-oriented, which means transactions are usually stored as messages within queues (such as Microsoft® Message Queuing (MSMQ), Enterprise Application Integration (EAI), TIBCO® Queuing Services, etc.) and processed in a first-in first-out (FIFO) manner. Each of such messages can contain a set of records that represent a transaction or a so called “unit of work,” which can be targeted to different database tables. In most of the Online Transaction Processing (OLTP) type processing techniques that are utilized today, a function is usually provided to read messages from a queue and present the records associated with these messages to a loading function on a record-by-record basis. In certain cases, these records need to be filtered, transformed, or cleansed in between the read step and the load step. These functional steps are mostly performed in a serial manner, especially when records in a transaction are order sensitive. While this single-threaded FIFO transaction processing is common practice for ADW solutions today, this approach inhibits parallel processing and scalability.

Thus, improved mechanisms for database processing are needed to reflect the real-time nature of transactions that enterprises experience today and to provide enterprises with up-to-date information and data analysis.

### SUMMARY

In various embodiments, techniques for real-time database processing are provided. More particularly, a method for real-time database processing is provided. Specifically, a directory is scanned for database transactions that are defined in files, which are located in the directory. Next, each of the files, within the directory, is processed in a user-defined order to a database. Finally, a checkpoint operation is initiated to indicate each of the files have been processed to the database.

### BRIEF DESCRIPTION OF THE DRAWINGS

FIG. 1 is a diagram of a method for real-time database processing, according to an example embodiment.

FIG. 2 is a diagram of another method for real-time database processing, according to an example embodiment.

FIG. 3 is a diagram of a real-time database processing system, according to an example embodiment.

### DETAILED DESCRIPTION

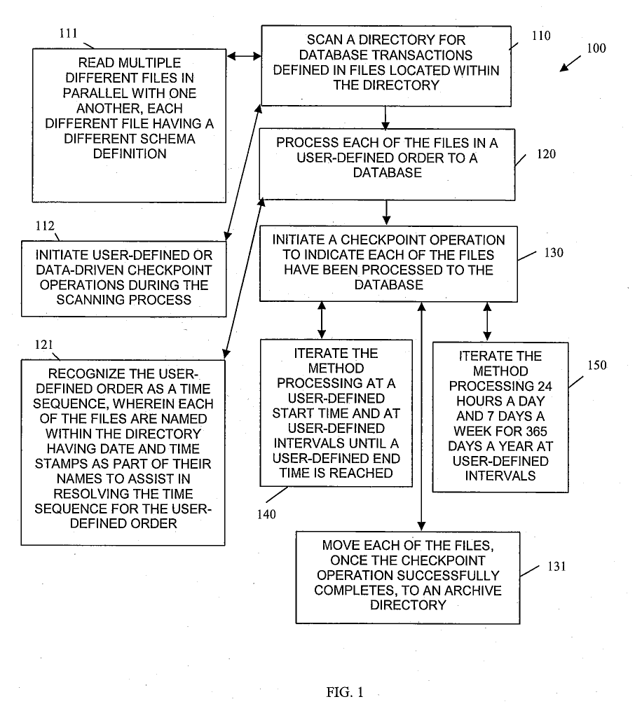

FIG. 1 is a diagram of a method 1 00 for real-time database processing, according to an example embodiment. The method 100 (herein after referred to as “real-time database transaction processing service”) is implemented in machine-accessible or computer-readable storage medium as instructions that are executed by one or more machines (processors, computers, etc.). Moreover, the real-time database transaction processing service is accessible over a network. The network may be wired, wireless, or a combination of wired and wireless.

As used herein the phrase “parallel processing data warehousing environment” refers to an active data warehouse (ADW) processing environment in which data is extracted, transformed, and loaded (referred to as “ETL”) in a parallel processing environment in real-time and in a dynamic fashion. So, data can be queried and updated simultaneously and in a real-time and dynamic manner.

One technique for such an environment and for processing modules that support operations in an ADW processing environment can be found with the Teradata Parallel Transporter® (referred to as “TPT”) product offering, distributed by Teradata Inc., of Dayton, Ohio. This product operates on the Teradata® product, which is a data warehouse and which is also distributed by Teradata Inc., of Dayton, Ohio. These techniques for the TPT and Teradata® are incorporated by reference herein.

A “database” as used herein refers to a data warehouse. The warehouse can be a relational database, a file, a queue, a table, directory, or other sources of data or combinations of these things that are logically organized and cooperate via interfaces as a single accessible and updatable entity or resource. Access to the database is achieved via an Application Programming Interface (API), such as but not limited to Structured Query Language (SQL), etc.

Essentially, in a parallel processing data warehousing environment software processes called “operators” provide access to external resources, such as files database management system (DBMS) tables, messaging middleware products, etc. and perform various filtering and transformation functions. A data stream data structure is used for interchanging data between operators. A typical data stream connects two operators: one of them known as a “producer,” which writes data to the data stream; and another one known as a “consumer,” which reads the data from the data stream.

Multiple instances of any given operator can be launched within the parallel processing data warehousing environment. Each instance is typically assigned to a system process or thread, and therefore, can execute independently of and concurrently (in parallel—at the same time) with the other instances. So, multiple instances of a producer operator collect data from multiple data sources; the data is written to the data stream by each instance of the operator data stream. The data streams are dynamically merged and split across multiple processing instances of the consumer operator that then uses the data.

Also, as used herein a “service” is a special type of resource that executes within the parallel processing data warehousing environment. In an embodiment, the service (when not qualified by any additional adjective) refers to a job within a parallel processing data warehousing environment or a component of the job, such as an operator discussed above (producer or consumer).

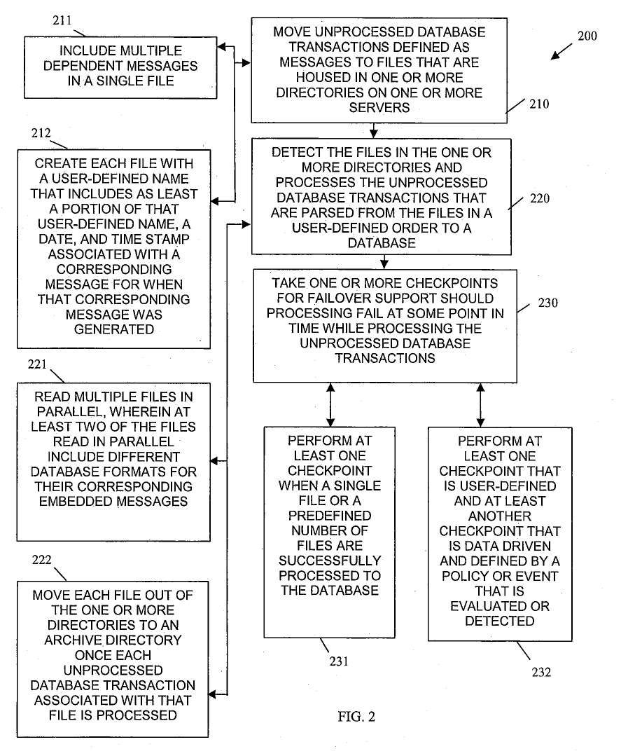

Users can interrupt an ETL job with asynchronous command processing service to perform job monitoring or controlling functions, which can be asynchronous command processing service-provided (internally) or user-defined (externally based). Users can also define their own rules for issuing these commands (discussed more completely below with reference to the method 200 of the FIG. 2). This rule-enabling capability can help improve operational efficiencies, streamline processing of their ETL jobs, and enable the enterprise to react to events in a more timely fashion.

It is within this initial context that the processing associated with the real-time database transaction processing service is now discussed in detail.

At 110, the real-time database transaction processing service scans a directory (or multiple directories) for database transactions that are defined in files; the files placed in the directory when ready for processing to the database. These can be any database transaction that are typically represented as messages and in some cases as SQL statements or SQL queries to do updates, etc.

By placing traditional database transactions, represented as SQL formatted messages in files, a variety of benefits can be realized. Files include metadata that can be used to enforce security. Files can also be archived, backed-up, and versioned using existing operating system (OS) and file system (FS) tools and services. Other message formats can also be embodied in the files such as, by way of example only, Microsoft® Message Queuing (MSMQ), Enterprise Application Integration (EAI), TIBCO® Queuing Services, etc. The traditional messaging queuing approach is altered to embody these unprocessed database transactions (represented as messages in a variety of disparate formats) into the files that are housed in the directory. The data can also be cleansed and transformed before they are loaded into files.

In some cases, the real-time database transaction processing service interacts with these message services and integrates multiple different messages into a single file in a normalized format, such as SQL or in some cases even eXtensible Markup Language (XML) format. In other cases, each different message type is housed in its own independent file within the directory.

According to an embodiment, at 111, the real-time database transaction processing service reads multiple different files in parallel using one or more reading operators that process in parallel with one another. Each file read may have a different schema or different data format from another (of the other files being read in parallel). So, the files can be processed in parallel from the directory, even when the files include messages and database transactions in different data formats. The different data formats representing unprocessed database transactions can be normalized into a standard format and placed in a stream for processing by another operator and for eventual commitment to the database. In this manner, multiple files with multiple data message formats are handled together as a single job in a parallel fashion.

In another embodiment, at 112, the real-time database transaction processing service can initiate user-defined or data-driven checkpoint operations during the scanning process. A user can include a variety of policies or profiles that define when the real-time database transaction processing service should initiate a checkpoint operation. A checkpoint operation encapsulates a processing state that can be resumed or continued in the event of a failure so the proper state and operations can be processed to the database without having to start completely over.

At 120, the real-time database transaction processing service processes each of the files in a user-defined order to a database for commitment and subsequent updating to the database. This may entail passing a data stream of transactions to a load or commitment operation associated with the database. The stream itself can be processed in parallel by multiple different instances of available operators. The order of processing the files is user-defined.

In an embodiment, at 121, the real-time database transaction processing service recognizes the user-defined order as a time sequence or a serial order that is dictated by time. Here, each file within the directory includes as part of its name within the directory date and time stamps. The part of the file's name that includes the date and time stamps assist the real-time database transaction processing service in resolving the proper time sequence for the user-defined and user-directed order.

It is noted that the user can also provide a sort order for the files within the directory by creating files in a directory based on time order, and the real-time database transaction processing service can process the files within the directory based on file creation order. Any user-defined criteria can be used to define the order for the files being maintained in the directory.

At 130, the real-time database transaction processing service initiates a checkpoint operation to indicate when each of the files has been processed to the database. That is, a checkpoint operation indicates that particular files have been successfully sent for commitment and processing to the database and do not have to be repeated in the event of a failure. So, should the real-time database transaction processing service fail, files that have already been processed will not be re-processed again when the real-time database transaction processing service successfully comes online again.

According to an embodiment, at 131, the real-time database transaction processing service moves each of the files once the checkpoint operation successfully completes to an archive directory. This ensures that if a failure occurs these files are not even looked at for reprocessing and it also ensures that transaction logs, version history, and backup procedures can still access these files in the event that unexpected operations occur or unauthorized operations occur after the files are processed to the database.

In one situation, at 140, the entire method 100 is iterated and processed at a user-defined start time for user-defined intervals until a user-defined end time is reached. So, for example, a user may start processing files at 1:00 am and continue until 7:00 am and process every 10 minutes. The start and end times can be open ended to achieve true real-time processing.

For example, at 150, the entire method 100 is iterated and processed 24 hours a day, 7 days a week, and 365 days a year. Here, the start time may be January 1^{st} at 12:00 am and the end time 11:59 pm on December 31^{st}. Moreover, the interval for iteration can be very small such as 1 minute or larger depending upon the needs of the user or an enterprise. In this manner close to or near real-time processing of enterprise database transactions can occur.

The files can be collected for processing in real-time, near real-time, in batches, or in mini batches. The configuration can be done via a user-defined policy and/or profile setting that the real-time database transaction processing service evaluates and configures itself to.

FIG. 2 is a diagram of another method 200 for real-time database processing, according to an example embodiment. The method 200 (hereinafter referred to as “real-time database service”) is implemented in a machine-accessible and computer-readable storage medium as instructions that when executed by a machine (processor, computer, etc.) performs the processing depicted in FIG. 2. Moreover, real-time database service is operational over a network, which may be wired, wireless, or a combination of wired and wireless.

The real-time database service provides another and in some cases enhanced perspective to the real-time database transaction processing service represented by the method 100 of the FIG. 1, discussed in detail above.

At 210, the real-time database service moves unprocessed database transactions, within an enterprise data warehouse environment, and which are defined as messages to files. The files are housed in one or more directories on one or more servers of the enterprise network.

According to an embodiment, at 211, the real-time database service includes multiple dependent messages in a single file. That is, policy may drive the real-time database service to aggregate multiple independent messages into a single file, such as when particular messages are dependent on processing of one another. Within the file, the defined order is the order with which the real-time database service will eventually process the database transactions to ensure the dependencies are met properly.

In another case, at 212, the real-time database service creates each file with a user-defined name that includes as at least a portion of that user-defined name a date and time stamp for the corresponding message to which that file relates. The date and time stamp reflects when a message was generated and not necessarily when the file was created. This ensures the unprocessed database transaction is processed in the proper order with respect to other files that have later date and time stamps for their messages.

At 220, the real-time database service detects the files in one or more directories and processes the unprocessed database transactions that are parsed from the files in a user-defined order to a database. So, the user can define via criteria embedded in policy or profiles the sort order for the files or the processing order for the files.

In an embodiment, at 221, the real-time database service reads multiple files in parallel, where at least two of the files read in parallel include different database formats for their corresponding embedded messages. Again, multiple read or load operators can be used to achieve this to create a single stream of unprocessed database transactions that are to be subsequently passed off as a job for processing to other operators to update the database.

In still another situation, at 222, the real-time database service moves each file out of the one or more directories to an archive directory once each unprocessed database transaction associated with that file is processed (committed to an operator for updating the database via a data stream of unprocessed database transactions).

At 230, the real-time database service takes one or more checkpoints for failover support should processing fail at some point in time while processing the unprocessed database transactions that are embedded in the files within the directories. The checkpoint ensures that the entire process is not unnecessarily repeated and ensures a proper recovery point is reached should a failure occur.

According to an embodiment, at 231, the real-time database service performs at least one checkpoint when a single file or predefined number of files (set of files) are successfully processed to the database. A user can define this checkpoint operation to occur after a certain type of files is processed or a certain number of files is processed. So, control of checkpoint operations can be user defined based on the user's experience with his/her data warehouse environment and what is optimal in their view.

In yet another case, at 232, the real-time database service performs at least one checkpoint that is user-defined and at least one other checkpoint that is data driven and defined by a predefined policy or event that is evaluated or detected.

So, the order of file processing and the time for checkpoints are capable of being controlled by a user, via configuration settings, policies, and/or profiles that the real-time database service evaluates, configures to, and enforces during its processing cycles.

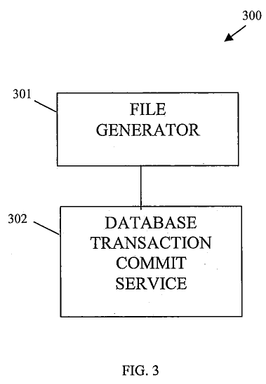

FIG. 3 is a diagram of a real-time database processing system 300, according to an example embodiment. The real-time database processing system 300 is implemented in a machine-accessible and computer-readable storage medium as instructions that when executed by a machine(s) (processor(s), computer(s), etc.) performs a variety of processing, such as the processing discussed in detail above with reference to the methods 100 and 200 of the FIGS. 1 and 2.

The real-time database processing system 300 includes a file generator 301 and a database transaction commit service 302. Each of these and their interactions with one another will now be discussed in detail.

The file generator 301 is implemented within a machine-accessible and computer-readable storage medium as instructions that are executed by a processor of a network. Example aspects of the file generator 301 were presented in detail above with reference to the methods 100 and 200 of the FIGS. 1 and 2, respectively.

The file generator 301 gathers messages for unprocessed database transactions from a plurality of disparate sources and produces files having these unprocessed database transactions. The file generator 301 stores the files in one or more directories on one or more servers.

According to an embodiment, the file generator 301 names the files within the one or more directories with user-defined naming criteria.

In another case, the file generator 301 sorts the files within the one or more directories via user-defined sort criteria.

The database transaction commit service 302 is implemented in a machine-accessible and computer-readable storage medium as instructions that are executed by the same processor as the file generator 301 or by a completely different processor of the network. Example aspects of the database transaction commit service 302 were presented in detail above with reference to the methods 100 and 200 of the FIGS. 1 and 2, respectively.

The database transaction commit service 302 periodically scans the one or more directories for the files and commits the embedded unprocessed database transactions to a database for processing.

In an embodiment, the database transaction commit service 302 processed each file as soon as it is detected as being placed in the one or more directories.

In another case, the database transaction commit service 302 scans the one or more directories for the files at user-defined intervals.

In still another situation, the database transaction commit service 302 takes checkpoints each time a particular file and its unprocessed database transactions has been successfully committed to the database for processing.

The active directory scanning technique presented herein not only exploits the power of scalability and parallelism for real-time transactional processing, but also enables the high-performance bulk-loading mechanism, such as “batch directory scanning” to be deployed in both traditional and ADW environments. The combination of TPT scalability features, load protocol switching, event-driven checkpointing, and the flexibility of mixing batch directory scans and active directory scanning allows customers to obtain a much better balance of data freshness, throughput performance, and system resource usage in their ADW environments. Moreover, recovery can be done in a more systematic and automated manner because of the simplicity and uniformity of file-oriented checkpoint re-startability, which results in faster recovery procedures for addressing different types of system and application failures.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method implemented in a computer-readable storage medium and processed by a processor to perform the method, comprising:
scanning a directory for database transactions defined in files located within the directory;
processing each of the files in a user-defined order as the database transaction are applied to a database; and
initiating a checkpoint operation to indicate each of the files have been processed to the database.

2. The method of claim 1 further comprising, iterating the method processing at a user-defined start time and at user-defined intervals until a user-defined end time is reached.

3. The method of claim 1 further comprising, iterating the method processing 24 hours a day and 7 days a week for 365 days a year at user-defined intervals.

4. The method of claim 1, wherein scanning further includes reading multiple different files in parallel with one another, each different file having a different schema definition from the others.

5. The method of claim 1, wherein scanning further includes initiating user-defined or data-driven checkpoint operations during the scanning process.

6. The method of claim 1, wherein processing further includes recognizing the user-defined order as a time sequence, wherein each of the files are named within the directory having date and time stamps as part of their names to assist in resolving the time sequence for the user-defined order.

7. The method of claim 1, wherein initiating further includes moving each of the files once the checkpoint operation successfully completes to an archive directory.

8. A method implemented in a computer-readable storage medium and processed by a processor to perform the method, comprising:
moving unprocessed database transactions defined as messages to files that are housed in one or more directories on one or more servers;
detecting the files in the one or more directories and processing the unprocessed database transactions parsed from the files in a user-defined order to a database; and
taking one or more checkpoints for failover support should processing fail at some point in time while processing the unprocessed database transactions.

9. The method of claim 8, wherein moving further includes including multiple dependent messages in a single file.

10. The method of claim 8, wherein moving further includes creating each file with a user-defined name that includes as least a portion of that user-defined name a date and time stamp associated with a corresponding message for when that corresponding message was generated.

11. The method of claim 8, wherein detecting further includes reading multiple files in parallel, wherein at least two of the files read in parallel include different database formats for their corresponding embedded messages.

12. The method of claim 8, wherein detecting further includes moving each file out of the one or more directories to an archive directory once each unprocessed database transaction associated with that file is processed.

13. The method of claim 8, wherein taking further includes performing at least one checkpoint when a single file or a predefined number of files are successfully processed to the database.

14. The method of claim 8, taking further includes performing at least one checkpoint that is user-defined and at least another checkpoint that is data driven and defined by a policy or event that is evaluated or detected.

15. A computer-implemented system that executes on one or more processors, the system comprising:
a file generator implemented in a computer-readable storage medium and to execute on a processor of a network; and
a database transaction commit service implemented in a computer-readable storage medium and to execute on the processor or a different processor of the network;
wherein the file generator gathers messages for unprocessed database transactions from a plurality of disparate sources and produces files having these unprocessed database transactions, and wherein the file generator stores the files in one or more directories on one or more servers, and wherein the database transaction commit service periodically scans the one or more directories for the files and commits the embedded unprocessed database transactions to a database for processing.

16. The system of claim 15, wherein the file generator names the files within the one or more directories with user-defined naming criteria.

17. The system of claim 15, wherein the file generator sorts the files within the one or more directories via user-defined sort criteria.

18. The system of claim 15, wherein the database transaction commit service processes each file as soon as it is detected as being placed in the one or more directories.

19. The system of claim 15, wherein the database transaction commit service scans the one or more directories for the files at user-defined intervals.

20. The system of claim 15, wherein the database transaction commit service takes checkpoints each time a particular file and its unprocessed database transaction has been successfully committed to the database for processing.
